(19) United States
(12) Patent Application Publication
(10) Pub. No.: US 2024/0319071 A1
(43) Pub. Date: Sep. 26, 2024

(54) BIAXIAL LOADCELL ACTUATOR FOR VACUUM TRIBOMETER

(71) Applicant: The Florida State University Research Foundation, Inc., Tallahassee, FL (US)

(72) Inventors: Joseph Lupton, Tallahassee, FL (US); Brandon Alexander Krick, Tallahassee, FL (US)

(21) Appl. No.: 18/590,371

(22) Filed: Feb. 28, 2024

Related U.S. Application Data
(60) Provisional application No. 63/448,874, filed on Feb. 28, 2023.

(51) Int. Cl. G01N 19/02

(52) U.S. Cl. CPC G01N 19/02

(57) ABSTRACT

Described and disclosed herein are embodiments of a tribometer. In some instances the tribometer comprises an actuator system composed of a monolithic biaxial load cell with an integrated sample holder, a flexure, and an amplified piezo actuator.

### CROSS REFERENCE TO RELATED APPLICATION

This application claims priority to and benefit of U.S. provisional patent application No. 63/448,874 filed Feb. 28, 2023, which is fully incorporated by reference and made a part hereof, including all appendices.

### BACKGROUND

A tribometer is any device used to measure friction of a material system. Historically, tribometers have been devices as simple as a pulley sliding a block across a counter surface or a tilted countersurface with an unconstrained sample. These devices were prone to measurement errors and system inaccuracies due to human error and environmental fluctuations.

Modern tribometers are complex mechatronic systems that are comprised of a few common subsystems including the loading mechanism, force measurement device, and actuation. In short, these tribometers induce motion between a sample and countersample with prescribed normal load, velocity, and sometimes environmental conditions (temperature, humidity, air composition, etc.). Further, when paired with certain measurement techniques such as periodic massing or in-situ profilometry, system wear rates can also be determined.

To add another means of fine-tuning the system, the shape of the sample and countersample can be changed along with the type of motion. Common combinations include ball on disk, cylinder on disk, ball on plate, and pin on plate, where plates provide linear reciprocating motion and disks provide rotary or rotary reciprocating motion.

All tribometers are designed to test the coefficient of friction between a pair of materials that are typically referenced as the sample and countersample. One of these materials (in the case of this design, the sample) is attached to a platform designed to induce motion, and the other material (countersample) is attached to an actuator that is used to generate a load between the two samples.

Once a load is applied between the material pair, motion is induced, generating friction. Using a load cell in the normal and lateral directions, the coefficient of friction can be determined.

With recent advancements in tribometers and the science of tribology in general, the ability to fine tune tribomaterials for specific applications is at an all-time high. As such, with the revitalization of the space industry, the desire to create tribomaterials that can survive microgravity, high vacuum, atomic oxygen, and large temperature variations for the lifespan of space projects is in demand. Although it is possible to test all of these independently, it is nearly impossible to predict co-dependencies with any certainty. This issue can be addressed by creating a tribometer that operates in space environments whether it is on a CubeSat, the International Space Station (ISS), or the moon.

Starting in 2001, just three years after the ISS was launched, the Materials International Space Station Experiment (MISSE) series has hosted passive materials experiments to determine how environmental factors effect material properties. Starting on the 5th MISSE experiment series, active experiments were permitted.

Therefore, what is desired is a tribometer that overcomes challenges in the art, some of which are described above. In particular, a tribometer capable of fully autonomous operation upon the MISSE platform is desired.

### SUMMARY

Disclosed and described herein is a tribometer comprising an actuator system composed of a monolithic biaxial load cell with an integrated sample holder, a flexure, and an amplified piezo actuator. The biaxial load cell uses a slotted double-hole design to produce the strain required for the measurement of forces with a resolution of approximately 1 millivolt per volt at 1 newton of load. The full system has a displacement resolution of approximately 1.53 microns per bit with a 10-bit controller resulting in a force application resolution of 10 millinewtons per bit. The actuator system functions by applying a voltage ranging from 0 to 150 volts to the amplified piezo actuator, which bends the flexure that acts like a sprung fulcrum. The result is a revolute motion of the sample holder and load cell that imposes a load when the sample and countersample (external to this system) come in contact. The actuator system is capable of being powered with less than 2.5 watts and fits into a 1″ by 1″ by 2.5″ volume. The actuator system is capable of being used in vacuum or space environments due to the material selection. The primary use for this system is the application of a precise load between two material samples in a tribological testing environment.

Advantages of embodiments of the disclosed tribometer include easier tuneability and manufacturability than prior art tribometers (see, for example, Brandon A Krick and Gregory Sawyer. “Space tribometers: design for exposed experiments on orbit.” In: Tribology letters 41.1 (2011), pp. 303-311, which is fully incorporated by reference). By using separate components as an assembly instead of a fully monolithic system, manufacturing becomes far simpler. Further, the use of slotted biaxial load cells instead of bar-style allows for a larger variety of materials to be used and more tuneability when it comes to load application, strain gauge application, and sensitivity. By putting the amplified piezo actuator on the other side of the flexure (i.e., the side away from the load), a larger lever arm can be created, and more amplified piezo amplifiers are available for selection to improve the systems tunability. Additional advantages include its compact size and the components being used. The components being used, specifically the amplified piezo actuator, allow for the system to work in space or vacuum environments. Further, the assembly allows for an easy to manufacture, light weight system with few moving parts that may require maintenance. On a more extended basis, the controllability of these components is much simpler than that of a typical stepper motor driven assembly.

Other devices, systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The following detailed description will be better understood when read in conjunction with the appended drawings, in which there is shown one or more of the multiple embodiments of the present disclosure. It should be understood, however, that the various embodiments of the present disclosure are not limited to the precise arrangements and instrumentalities shown in the drawings.

FIG. 1 is an exemplary block-diagram illustration of one of the embodiments of a tribometer disclosed herein.

FIG. 2 is a rendering of an exemplary tribometer in accordance with the sub-systems and sub-components described in relation to FIG. 1, above.

FIG. 3 is an illustration of an application of embodiments of a tribometer as described herein.

FIG. 4 is a graph illustrating simulation results to determine lateral stiffness, with a 10× deformation scale.

FIG. 5 illustrates Falcon 9 rocket expected payload attachment vibration levels.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

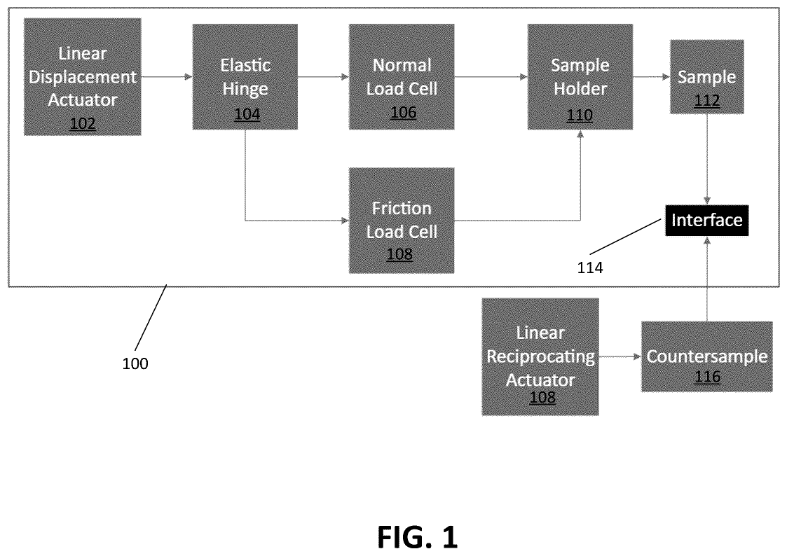

FIG. 1 is an exemplary block-diagram illustration of one of the embodiments of a tribometer disclosed herein. As shown in FIG. 1, the exemplary tribometer biaxial loadcell actuator 100 is comprised of a plurality of sub-systems or sub-components. These sub-systems or sub-components include a linear displacement actuator 102, an elastic hinge 104, a normal load cell 106, a friction load cell 108, and a sample holder 110 that holds a sample 112. The sample 112 creates an interface 114 with a countersample 116 that is moved by a linear reciprocating actuator 118.

The linear displacement actuator 102 generates an extending displacement and force capable of actuating the elastic hinge 104 with a residual force that can be applied at the sample interface 114. The disclosed embodiments utilize linear displacement methods that do not include a sliding mechanism, thus providing a compact design that does not need lubricants (allowing vacuum and space compatibility). For example, the linear displacement actuator 102 may comprise an Amplified Piezo Actuator (APA). In other instances, the linear displacement actuator may comprise a ball screw with a stepper motor, a lead screw with a stepper motor, a hydraulic linear actuator, a pneumatic linear actuator, and the like.

The elastic hinge or flexure 104 allows for an amplification of the displacement from the linear displacement actuator 102 to the sample 112. It also allows for the actuator 102 to only generate force in one direction. No force retraction is needed from the linear displacement actuator 102 because it is provided by the spring-like hinge 104. By manipulating the geometry of the hinge 104, the force resolution can be tuned. The geometry of this hinge 104 also allows for easy manufacturability compared to hinges used in conventional tribometers as this hinge 104 is a distinct and separate component. The elastic hinge or flexure 104 may be comprised of any engineering metal with a high strain to failure and fatigue life, ideally with a low elastic modulus. For example, the elastic hinge or flexure 104 may be comprised of titanium or spring steel. In one aspect, the elastic hinge or flexure 104 is comprised of approximately 0.038″ spring steel shim stock. In another aspect, the elastic hinge or flexure 104 is comprised of 0.006″ titanium shim stock, though other materials and dimensions are considered within the scope of this disclosure.

The load cells 106, 108 comprise a lateral 108 and a normal 106 force load cell. The material that comprises the load cell 106, 108 and its hole configuration may be selected to aid in manufacturing and to control the exact resolution of the force being measured. In one aspect, the load cells 106, 108 comprise dual monolithic 7075 aluminum load cells with a slotted double hole configuration, though other configurations and/or materials are contemplated within the scope of this disclosure including other aluminum blends (e.g., 6061, 6060), titanium, stainless steel, and the like, and other configurations including individual load cells mounted in series, mounted by welding, adhesives, or fasteners, and the like.

The sample holder 110 is used to constrain the sample's 112 motion in any direction while allowing for contact with the counter sample 116. For example, the sample holder 112 may be integrated into the load cells 106, 108 to reduce the compliance of the system due to fasteners. In some instances, the sample holder 112 uses a bolt to hold a T-shaped or ball sample down. In other aspects, built in samples may be used (i.e., the “sample holder” is the sample), while in other aspects the sample holder 112 may comprise a press-fit sample holder, U-clamps, shaft and set screw, hinged spring clamps and the like.

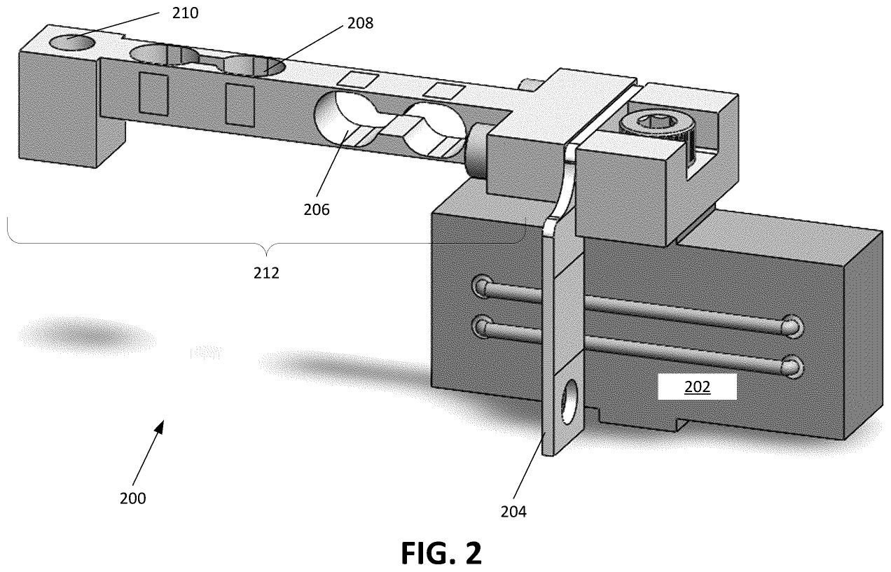

FIG. 2 is a rendering of an exemplary tribometer 200 in accordance with the sub-systems and sub-components described in relation to FIG. 1, above. As shown in FIG. 2, the exemplary tribometer 200 is comprised of a linear displacement actuator 202, an elastic hinge or flexure 204, a normal load cell 206, a friction load cell 208, and a sample holder 210. Not shown in is FIG. 2 is the actual sample 112, or the interface 114 of the sample 112 with a countersample 116 that is moved by a linear reciprocating actuator 118.

In the example shown in FIG. 2, the linear displacement actuator 202 comprises an amplified piezo actuator (APA). Piezoactuators are generally piezoelectric materials that have a surrounding flexure capable of extending actuation while decreasing loading potential. Due to the nature of piezoelectric materials, they tend to act as a spring where displacement is also proportional to an induced voltage. Using this relationship, it is found that as the actuator extends, the amount of force it can produce decreases linearly. A benefit of piezoactuators is that they provide excellent displacement resolution and require very little current depending on how they are controlled.

The elastic hinge or flexure 204 thickness can be selected by choosing a shim that allows for the lowest spring stiffness without yielding or risking fatigue at the desired displacement. For example, in one instance 0.038″ spring steel shim stock was selected. It is also possible to use many other materials (e.g., titanium)/thicknesses for the flexure 204. After the flexure material and thickness were selected for the exemplary embodiment of FIG. 2, a study was run to determine the displacement of the load head, piezo actuator, and flexure stress for varying APA supply voltages. Using this data, a 2D footprint of the flexure was modified until stress fell below the threshold for a 1.5 yield strength Factor of Safety (FOS) and 10,000 cycle fatigue limit. After finalizing the flexure and ensuring its life would be adequate, a piezoactuator was selected. For example, the actuator 202 may be a FPA-0200E-S-0518 (Dynamic Structures & Materials, Inc., Franklin, TN), which provides a minimum volume capable of producing a 1.25 FOS for both travel and force at the desired displacement. The flexure 204 is generally designed in a U-shape to allow for a compact assembly. The purpose of the flexure is to act as a sprung fulcrum, allowing for the amplified piezo actuator to have resistance in expansion but be aided in retraction. The spacing of the amplified piezo actuator mounting point, the flexure, and the length of the biaxial load cell create a specific mechanical advantage while maintaining mechanical safety.

In the exemplary embodiment of FIG. 2, the resultant elastic hinge and piezoactuator combination provides a loading scheme that was capable of deflecting 0.35 mm plus the deflection of the load head when loaded at 1N (0.14 mm).

In the exemplary embodiment of FIG. 2, the normal load cell 206 and friction load cell 208 comprise a load head 212 that includes an integrated sample holder 210. The biaxial load cells 206, 208 each take advantage of a double-hole slotted configuration. In one non-limiting example, the load head 212 can be machined out of 7075 aluminum and is designed for easy manufacturing. The exemplary design provides a monolithic bidirectional load cell with an integrated sample holder. A monolithic design reduces the possibility of misalignment and provides direct control over measurement sensitivity and component size. In the exemplary embodiment shown, the load cells were designed based on strain gauges with a gauge factor of 2.1, width of 4.4 mm, 6.7 mm center spacing, and a 4.5 mm by 2.2 mm resistor area. The desired sensitivity of the device was 1 mV/V leading to a required strain of 0.48 mϵ, meaning that with under 1 Newton of loading, the average measured strain is approximately 0.48 milliepsilon. This is used to determine the application force through the use of strain gauges and a Wheatstone bridge. The load cell can withstand approximately 7 Newtons of loading at this resolution and has a nearly infinite fatigue life. The end effector of the load head 212 comprises a sample holder 212 capable of holding, for example, 3-millimeter ball samples or pins.

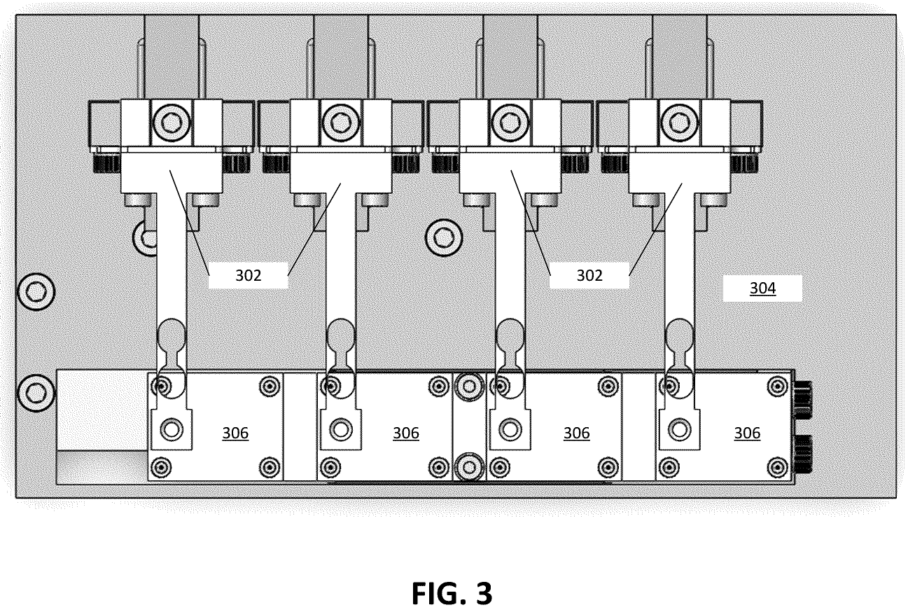

FIG. 3 is an illustration of an application of embodiments of a tribometer as described herein. In FIG. 3, a plurality of tribometers 302 (in this instance, four, but more or fewer tribometers may be used) are mounted on a deck 304. For example, the deck may be an exposure deck. Each tribometer 302 comprises a stage of a multi-stage tribometer application. Each tribometer 302 is associated with its own test bed 306, that comprises the countersample 116. The test bed 306 is moved by the linear reciprocating actuator 118. In some instances, all of the countersamples 116 are affixed to a test bed 306 and are moved in unison by the same linear reciprocating actuator 118, while in other instances each countersample 116 is moved on an individual test bed 306 by its own linear reciprocating actuator 118. In some instances, the multi-stage tribometer has dimensions of 6″×3″×3″ (L×W×H), or less.

### Performance and Testing

In a non-limiting example, a tribometer in accordance with the embodiments described herein was developed and tested. The results of this testing are described herein.

### 1. Mechanical Simulations

### 1.1 Lateral Stiffness

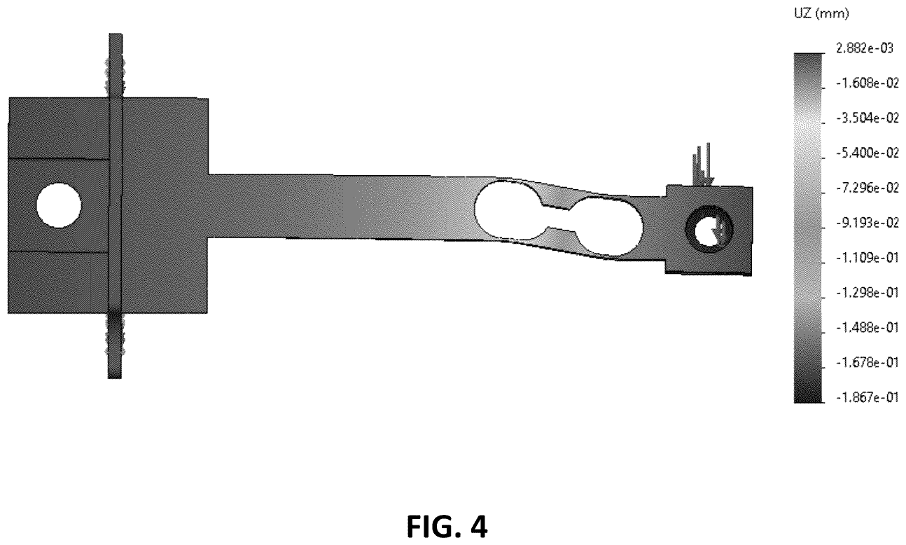

After fine tuning the assembly, a lateral simulation was run to measure the effective lateral spring stiffness of the flexure and ensure that it would not affect the friction force measurement through stick-slip action. The simulation was setup as seen in FIG. 4, Simulation Results to Determine Lateral Stiffness, 10× Deformation Scale, with the flexure mounted rigidly and a 1N force on the end of the load cell. The resulting angular displacement allowed by the flexure is 0.025° disregarding the APA stiffness. This yields a small offset of 0.02 mm at the sample and should not result in any significant stick-slip compared to the load cell's allowable displacement.

### 1.2 30G Shock Test

The Falcon 9 Payload guide (Falcon 9 Launch Vehicle Payload User's Guide. Tech. rep. SpaceX, 2009, which is fully incorporated by reference) provides a few different frequency-shock values at the payload adapter that may occur during vehicle release at liftoff, stage separation, spacecraft separation, and fairing deployment. Assuming that the MISSE testbed will act as a low pass filter for vibrations due to the chain of spring-like materials in series. Only the 100 Hz shock of 30G is being considered.

To simulate this at a worst case, a 30G load was applied to both axes individually. This resulted in a maximum stress of 28.5 MPa and displacement of 58 μm, which is essentially the same as a 0.68N load on the sample. Based on these margins, there will not be any collisions, and the load cell is well within its stress and fatigue limits.

### 1.3 Load Cell Simulations

The bi-axial load cell was simulated in Solidworks™ thoroughly to balance manufacturability with the desired endurance and sensitivity. The majority of these tests were completed to optimize the slot geometry. At first, the simulations were run with a draft mesh to simulate rapidly. After the geometry was decided on, the mesh density was increased drastically to make the simulation as realistic as possible, in an effort to predict the sensitivity and spring constant of the load cell based on average strain.

With this high-density mesh, a spring constant of 7.396 N/mm was found with a corresponding sensitivity of 1.04 mV/N. The value of sensitivity was extremely close to the desired 1 mV/N. The stiffness was primarily a byproduct of the geometric design; however, it also requires balancing. The higher the stiffness, the higher the first resonant frequency but the harder it is to control the system with a position-based input.

### 1.4 Takeoff Vibration Testing

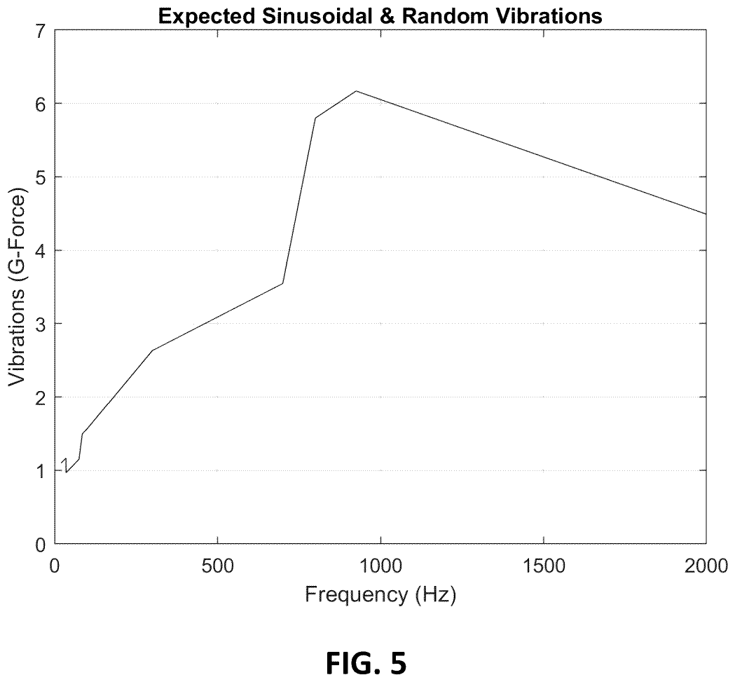

The expected vibrations at the payload connector can be seen in FIG. 5, Falcon 9 Rocket Expected Payload Attachment Vibration Levels, based on the sinusoidal and random vibrations provided by the Falcon 9 Launch Vehicle Payload User's Guide. Compared to the 30G shock simulation, the expected G-forces due to vibration are expected to be rather inconsequential in the steady state. The issue arises when we consider the frequency response and the natural frequency of the system, primarily the load cells. Through simulation, it was found that the natural frequency of the load cells with a rigid connection at its base is approximately 430 Hz. To avoid critical system failure, the vibration levels reaching the loading mechanism should be damped as much as possible. To achieve this, the APA, flexure, connection to the MISSE platform, and connection to the testbed should all be analyzed as either spring-mass or spring-mass-damper systems. To reduce these vibrations, it may be easiest to mount the exposure platform (the platform that the flexures and APA are mounted to) to the MISSE platform or motor framing with high-damping, low spring constant, standoffs. This will prevent the vibrations of both the motor and rocket from affecting the load heads significantly.

### 2 System Testing

Throughout the development process, individual components of the system were tested to either record the real performance or verify that a particular subsystem works as expected. The major components that were tested were the load-cell, actuation electronics, analog to digital converter, amplifier, encoder, and all associated software.

### 2.1 Load Cell Testing

After strain gauges were applied to the load cell, a lab operational amplifier with a fixed gain of 2000 and excitation voltage of 5 was used to determine the sensitivity of each axis. To do so, four masses from 21.94 g to 100 g were placed on the end of the load cell, and the change in voltage was measured. The sensitivity is simply the change in voltage divided by the weight, gain, and excitation voltage. As it can be seen in Table 1, below, there are slight biases for each axis, but the actual average sensitivity for all four directions combined is 0.96 mV/N, which is extremely close to the desired sensitivity of 1.0 mV/N given the complexity of manufacturing such a small component.

TABLE 1
Load Cell Testing Sensitivity Data

| | |
|---|---|
| (a) Sensitivity Data, Normal | (b) Sensitivity Data, Friction |

| $Load ( g ) Sensitivity ( \frac{mV}{N} )$ | | $Load ( g ) Sensitivity ( \frac{mV}{N} )$ | |
|---|---|---|---|
| Normal Load (−) | | Friction Load (−) | |
| 21.94 | 0.976 | 21.94 | 0.939 |
| 43.69 | 1.024 | 43.69 | 0.933 |
| 86.35 | 1.002 | 86.35 | 0.940 |
| 100.0 | 0.977 | 100.0 | 0.934 |
| Normal Load (+) | | Friction Load (+) | |
| 21.94 | 0.952 | 21.94 | 0.946 |
| 43.09 | 0.945 | 43.69 | 0.943 |
| 86.35 | 0.978 | 86.35 | 0.948 |
| 100.0 | 0.985 | 100.00 | 0.947 |

After determining the sensitivity of the load cell, a Z-axis micrometer on the test stand was used to deflect the load head to three fixed displacements. At each displacement, the voltage was measured. To determine the stiffness, the load was calculated from the voltage and sensitivity, and then the slope was taken. The resulting stiffness was 10,081 N/m, much higher than the expected 7,400 N/m. This difference could have been caused by simulation inaccuracies, manufacturing inaccuracies, or changes in material properties due to the thermal and stress environment produced by machining.

### CONCLUSION

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A tribometer comprising:
a linear displacement actuator;
an elastic hinge;
a monolithic biaxial load head comprising a normal load cell, a friction load cell, and an integrated sample holder for holding a sample, wherein the sample 112 creates an interface with a countersample that is moved by a linear reciprocating actuator; and
wherein the elastic hinge provides an amplification of displacement from the linear displacement actuator to the sample and wherein the actuator only generates force in one direction, no force retraction is needed from the linear displacement actuator because it is provided by the elastic hinge.

2. The tribometer of claim 1, wherein the linear displacement actuator comprises an Amplified Piezo Actuator (APA), a ball screw with a stepper motor, a lead screw with a stepper motor, a hydraulic linear actuator, or a pneumatic linear actuator.

3. The tribometer of claim 1, wherein the elastic hinge is comprised of spring steel or titanium.

4. The tribometer of claim 1, wherein the monolithic biaxial load head is comprised of aluminum.

5. The tribometer of claim 4, wherein the aluminum comprises 7075 aluminum.

6. The tribometer of claim 1, wherein the normal load cell and the friction load cell each comprise slotted double-hole load cells oriented perpendicular to one another.

7. The tribometer of claim 1, wherein a plurality of tribometers are mounted on a deck, each tribometer comprising a stage of a multi-stage tribometer and each tribometer associated with its own test bed comprising the countersample, wherein the test bed is moved by the linear reciprocating actuator.

8. The tribometer of claim 7, wherein all of the countersamples are affixed to the test bed 306 and are moved in unison by the same linear reciprocating actuator.

9. The tribometer of claim 7, wherein each countersample is moved on an individual test bed by its own linear reciprocating actuator.

10. The tribometer of claim 7, wherein the deck is an exposure deck.

11. The tribometer of claim 7, wherein the multi-stage tribometer has dimensions of 6″×3″×3″ (L×W×H), or less.

12. The tribometer of claim 1, wherein the tribometer is used in space.
